(19) United States
(12) Patent Application Publication
(10) Pub. No.: US 2026/0210744 A1
(43) Pub. Date: Jul. 23, 2026

(54) MAGNETIC-INDUCTIVE FLOWMETER

(71) Applicant: Endress+Hauser Flowtec AG, Reinach (CH)

(72) Inventors: Christoph Meyer, Birsfelden (CH); Markus Rüfenacht, Diepflingen (CH); Andre Spahlinger, Bad Bellingen (DE); Florent Tschambser, Hesingue (FR)

(21) Appl. No.: 19/141,690

(22) PCT Filed: Dec. 13, 2023
(86) PCT No.: PCT/EP2023/085595

§ 371 Date: Jun. 20, 2025

(30) Foreign Application Priority Data
Dec. 20, 2022 (DE) 10 2022 134 026.0

(51) Int. Cl. G01F 1/60; G01F 1/58; G01F 23/22

(52) U.S. Cl. CPC G01F 1/60; G01F 1/586; G01F 23/22

(57) ABSTRACT

A magnetic-inductive flowmeter for ascertaining a flow-velocity-dependent measurement variable of a flowable medium includes a measuring tube for conducting the medium, at least one measurement electrode and an additional electrode, and a magnetic-field-generating device. A measuring circuit with a microcontroller includes a first analog-to-digital converter configured to convert an analog flow measurement signal provided via the at least one measurement electrode into a digital flow measurement signal. A second analog-to-digital converter is configured to convert an analog test measurement signal provided via the additional electrode into a digital test measurement signal. The microcontroller is configured to extract the component of the digital test measurement signal from the digital flow measurement signal using a correlation and to determine the flow-velocity-dependent measurement variable using the corrected flow measurement signal, and/or determine a diagnostic variable or a process variable on the basis of the digital test measurement signal.

The invention relates to a magnetic-inductive flowmeter.

Magnetic-inductive flowmeters are used for determining the flow rate and the volumetric flow of a flowing medium in a pipe. A distinction is made here between in-line magnetic-inductive flowmeters and magnetic-inductive flow measurement probes, which are inserted into a lateral opening of a pipe. A magnetic-inductive flowmeter has a magnetic-field-generating device for generating a magnetic field. A main axis of the magnetic field runs substantially perpendicular to the flow direction of the flowing medium. Saddle coils or cylindrical coils are usually used for this purpose. In order to realize a predominantly homogeneous magnetic field, pole shoes are additionally formed and attached relative to the flow direction such that the magnetic field lines run over the entire tube cross-section substantially perpendicular to the transverse axis or parallel to the vertical axis of the measuring tube. In addition, a magnetic-inductive flowmeter has a measuring tube for conducting the medium on the outer lateral surface of which the magnetic-field-generating device is arranged. A pair of measurement electrodes attached to the lateral surface of the measuring tube taps a measurement voltage or potential difference which is perpendicular to the flow direction and to the magnetic field and arises when a conductive medium flows in the flow direction when the magnetic field is applied. Since, according to Faraday's law of induction, the tapped measurement voltage depends on the velocity of the flowing medium, the flow rate and/or, with the inclusion of a known tube cross-section, the volumetric flow can be ascertained from the measured induced measurement voltage.

In contrast to a magnetic-inductive flowmeter, which comprises a measuring tube for conducting the medium with an attached device for generating a magnetic field penetrating the measuring tube and which also comprises measurement electrodes, magnetic-inductive flow measurement probes are inserted with their usually circular cylindrical housings into a lateral opening of a pipe and fastened in a fluid-tight manner. A special measuring tube is no longer necessary. The measurement electrode arrangement and coil arrangement, mentioned at the outset, on the lateral surface of the measuring tube are omitted and are replaced by a device for generating a magnetic field, which device is arranged in the interior of the housing and in direct proximity to the measurement electrodes and is designed such that an axis of symmetry of the magnetic field lines of the generated magnetic field perpendicularly intersects the front face or the face between the measurement electrodes. In the prior art, there is already a plurality of different magnetic-inductive flow measurement probes.

Magnetic-inductive flowmeters are often used in process and automation engineering for fluids, starting from an electrical conductivity of approximately 5 μS/cm. Corresponding flowmeters are sold by the applicant in a wide variety of embodiments for various fields of application, for example under the names PROMAG or MAGPHANT.

EP 2 074 385 B 1 discloses a magnetic-inductive flowmeter with a measuring circuit configured to measure the flow, while a verification circuit is configured at the same time to measure multiple parameters of the magnetic-inductive flowmeter and to compare them with provided values. The parameters to be verified include coil resistance, coil inductance, electrode resistance, output signal, and current level of the drive signal. If the flow is measured during verification or diagnosis, an interaction between the verification signal or diagnostic signals and the measured flow measurement signal may occur, resulting in a measurement error.

### The Object of the Invention Is to Remedy This Problem.

The object is achieved by the magnetic-inductive flowmeter according to claim 1.

The magnetic-inductive flowmeter according to the invention for ascertaining a flow-velocity-dependent measurement variable of a flowable medium, comprising:
a measuring tube for conducting the medium;
at least one measurement electrode is arranged;
an additional electrode is arranged;
a magnetic-field-generating device for generating a magnetic field that penetrates the measuring tube at least in portions;
a measuring circuit with a microcontroller has a first analog-to-digital converter, which is electrically connected to the at least one measurement electrode and the microcontroller,
wherein the first analog-to-digital converter is configured to convert an analog flow measurement signal d provided via the at least one measurement electrode into a digital flow measurement signal D,
wherein the measuring circuit has a digital-to-analog converter, which is electrically connected to the additional electrode,
wherein the digital-to-analog converter is configured to convert a digital supplied test signal A provided via the microcontroller into an analog supplied test signal a and to feed the latter into the additional electrode,
wherein the measuring circuit has a second analog-to-digital converter, which is electrically connected to the additional electrode,
wherein the second analog-to-digital converter is configured to convert an analog test measurement signal a* provided via the additional electrode into a digital test measurement signal A*,
wherein the microcontroller is configured to extract the component of the digital test measurement signal A* from the digital flow measurement signal D using a correlation and to determine the flow-velocity-dependent measurement variable using the corrected flow measurement signal D′, and/or
wherein the microcontroller is configured to determine a diagnostic variable or a process variable on the basis of the digital test measurement signal A* and the, in particular digital, supplied test signal A, in particular simultaneously with the determination of the flow-velocity-dependent measurement variable.

According to the solution according to the invention, a diagnosis and a flow measurement can be carried out simultaneously without the diagnosis influencing the determination of the current flow. In terms of the invention, simultaneously means that the flow measurement does not have to be interrupted when a diagnosis is carried out. An analog supplied test signal a can also be fed in via one of the electrodes (measurement electrode, reference electrode, and/or fill-level monitoring electrode) if an induced measurement voltage is detected at the measurement electrodes and the measured values are also used to determine the flow-velocity-dependent measurement variable.

Advantageous embodiments of the invention are the subject matter of the dependent claims.

One embodiment provides for the additional electrode to be a fill-level monitoring electrode. The advantage of feeding the supplied test signal a via the fill-level monitoring electrode is the associated reduced disturbance of the flow measurement.

One embodiment provides for the additional electrode to be an additional measurement electrode.

One embodiment provides for the diagnostic variable to comprise information regarding a current fill level of the medium, the conductivity of the medium, a cable break of an electrical connecting line, the presence of gas bubbles at the measurement electrode and/or at the additional electrode and/or the presence of a deposit on the measurement electrode and/or on the additional electrode.

One embodiment provides for the test signal to be time-varying at least in portions and to have a test signal strength that alternates with at least one frequency.

One embodiment provides for the digital supplied test signal A to be time-varying at least in portions and to have a supplied test signal strength that alternates with at least two frequencies.

One embodiment provides for the digital supplied test signal A to consist of a superposition of at least two sinusoidal signals with different frequencies.

One embodiment provides for noise to be impressed on the digital supplied test signal A at least in portions.

One embodiment provides for the microcontroller to be configured to extract an, in particular digital, correlation test signal A″ from the digital flow measurement signal D.

The advantage of this embodiment is the resulting availability of an additional test signal, which provides an additional diagnostic option for the magnetic-inductive flowmeter.

One embodiment provides for the measuring circuit to be configured to determine a piece of information regarding a partial filling of the measuring tube on the basis of the digital correlation test signal A″ and the digital test measurement signal A*.

One embodiment provides for the measuring circuit to be configured to compensate for an influence of electronic components of the measuring circuit on the digital flow measurement signal D on the basis of a compensation variable ascertained from the digital correlation test signal A″ and the digital test measurement signal A*.

One embodiment provides for the magnetic-inductive flowmeter to comprise a first measurement electrode and a second measurement electrode,
wherein the first analog-to-digital converter is electrically connected to the first measurement electrode,
wherein the first analog-to-digital converter is configured to convert an analog first flow measurement signal d1 provided via the first measurement electrode into a digital first flow measurement signal D1,
wherein the measuring circuit comprises a third analog-to-digital converter, which is electrically connected to the second measurement electrode and the microcontroller,
wherein the third analog-to-digital converter is configured to convert an analog second flow measurement signal d1 provided via the second measurement electrode into a digital second flow measurement signal D2,
wherein the first flow measurement signal and the second flow measurement signal are also used, in particular in the form of a difference, to determine the flow-velocity-dependent measurement variable.

The invention is explained in greater detail with reference to the following figures, in which:

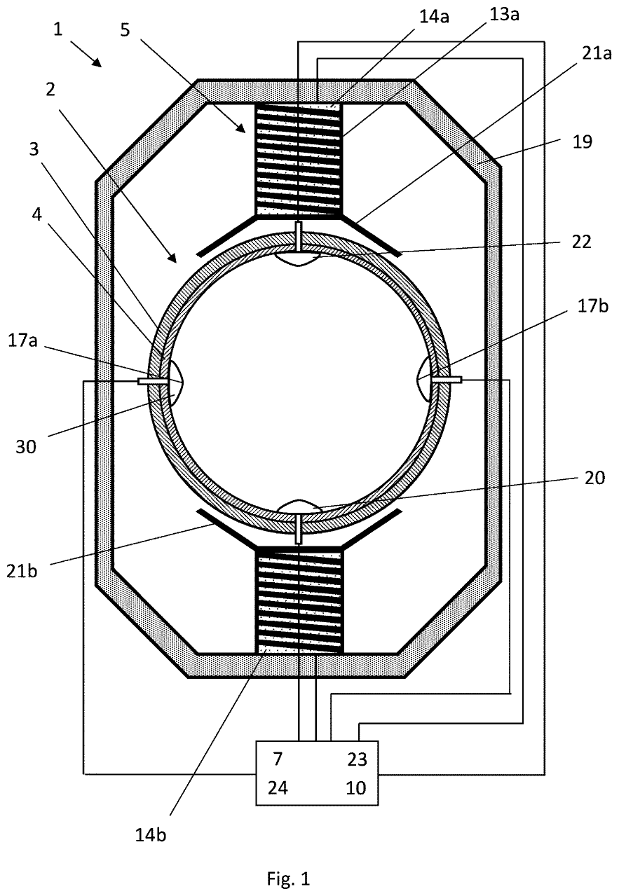

FIG. 1 shows a cross-section through a magnetic-inductive flowmeter according to the prior art;

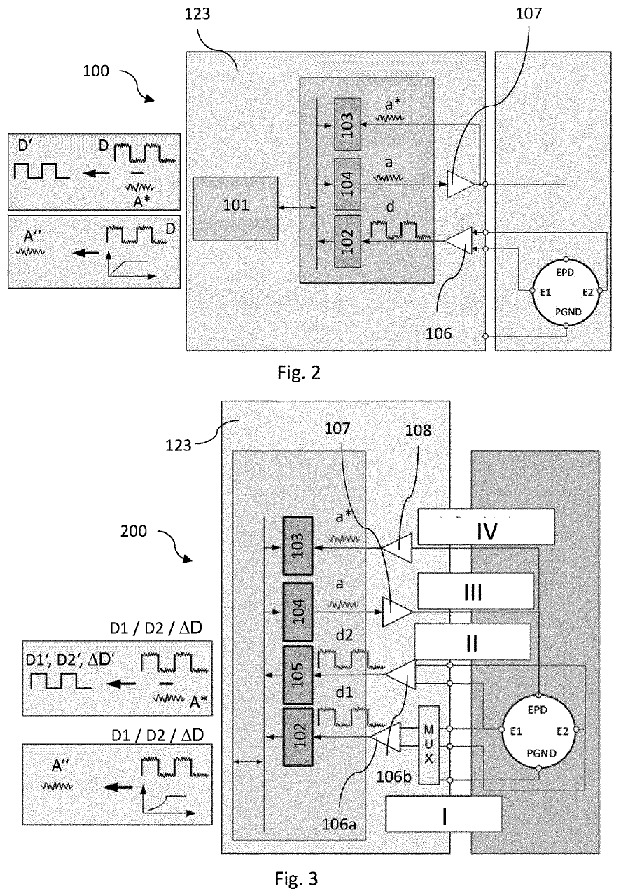

FIG. 2 shows a schematic representation of a first embodiment of the magnetic-inductive flowmeter;

FIG. 3 shows a schematic representation of a second embodiment of the magnetic-inductive flowmeter;

FIG. 1 shows a cross-section through a magnetic-inductive flowmeter 1 according to the prior art. The structure and measuring principle of a magnetic-inductive flowmeter 1 are known in principle. A flowable medium having an electrical conductivity is conducted through a measuring tube 2. The measuring tube 2 comprises a medium-contacting carrier tube 3, which is usually made of, or at least comprises, steel, ceramic, plastic, or glass. A magnetic-field-generating device 5 for generating a magnetic field is arranged on the carrier tube 3 such that the magnetic field lines are oriented substantially perpendicularly to a longitudinal direction defined by a measuring tube axis. The magnetic-field-generating device 5 usually comprises a saddle coil or at least one (cylindrical) coil 6i. A coil core 14i usually extends through a receptacle 15 of the coil 6i. The receptacle 15 is to be understood as the volume which is bounded by the coil wire that forms the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular magnetically soft, material. The device 5 for generating the magnetic field comprises a pole shoe 21i, which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The two coil cores 14a, 14b are connected to one another via a return path 22. The return path 22 connects the sides of the coil cores 14a, 14b that face away from one another. However, magnetic-inductive flowmeters with exactly one coil 6 having exactly one coil core 14 and without a return path are also known. The coil 6 is connected to an operating circuit 7, which operates the coil 6 by means of an operating signal. The operating signal can be a voltage with a time-varying curve and is characterized by operating signal parameters, wherein at least one of the operating signal parameters is controllable. The magnetic field generated by the magnetic-field-generating device 5 is generated by means of a pulsed direct current of alternating polarity provided by an operating circuit 7. This ensures a stable zero point and makes the measurement insensitive to influences due to electrochemical disturbances. The two coils 6a, 6b can be separately connected to the operating circuit 7 or connected in series or in parallel with one another.

When the magnetic field is applied, a flow-dependent potential distribution results in the measuring tube 2, which potential distribution can be detected, for example, in the form of an induced measurement voltage. A device 8 for tapping the induced measurement voltage is arranged on the measuring tube 2. In the embodiment shown, the device 8 for tapping the induced measurement voltage is formed by two oppositely arranged measurement electrodes 17a, 17b in order to form a galvanic contact with the medium. However, magnetic-inductive flowmeters which comprise measurement electrodes arranged on the outer wall of the carrier tube 3 that are not in contact with the medium are also known. The measurement electrodes 17a, 17b are generally arranged diametrically and form an electrode axis or are intersected by a transverse axis which runs perpendicular to the magnetic field lines and the longitudinal axis of the measuring tube 2. However, devices 8 intended for tapping the induced measurement voltage and having more than two measurement electrodes are also known. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is configured to detect the induced measurement voltage applied to the measurement electrodes 17a, 17b, and an evaluation circuit 24 is designed to ascertain the flow-velocity-dependent measurement variable. The evaluation circuit 24 can be part of the measuring transducer.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a liner 4 (made of plastic).

Commercially available magnetic-inductive flowmeters have two additional electrodes 19, 20 in addition to measurement electrodes 17a, 17b. On the one hand, a fill-level monitoring electrode 19 optimally attached at the highest point of the measuring tube 2 serves to detect partial filling of the measuring tube 1 and is configured to pass this information to the user and/or to take the fill level into account when determining the volumetric flow. In addition, a reference electrode 20, which is usually attached diametrically to the fill-level monitoring electrode 19 or at the lowest point of the measuring tube cross-section, serves to set a controlled electrical potential in the medium. As a rule, the reference electrode 20 is used to connect the flowing medium to a ground potential.

The operating circuit 7, controller circuit 10, measuring circuit 23, and evaluation circuit 24 can be part of a single electronic circuit or can form individual circuits. The measuring, operating and/or evaluation circuit 7, 23, 24 is configured to carry out the method according to the invention. For this purpose, the operating circuit is configured to generate the operating signal and provide it to the magnetic-field-generating device. Furthermore, the measuring circuit is configured to ascertain the measurement voltage values and pass them to the evaluation circuit. The evaluation circuit is configured to ascertain the current zero point and to take it into account for the determination of the flow-rate-dependent measurement variable.

FIG. 2 shows a schematic representation of a first embodiment of the magnetic-inductive flowmeter 100 according to the invention, in particular of the measuring circuit 123. The magnetic-inductive flowmeter 100 has a first measurement electrode E1, which is arranged in a measurement electrode opening of the measuring tube. The measurement electrode E1 is electrically connected to an amplifier 106. An additional second measurement electrode E2, which is also arranged in a measurement electrode opening provided for this purpose, is also connected to the amplifier 106.

The two measurement electrodes E1, E2 are configured to come into contact with the medium to be conducted. They are thus measurement electrodes that come into contact with a medium. The amplifier 106 is configured to ascertain a difference between the measurement signals provided by the two measurement electrodes E1, E2. The measurement signal can in each case be the time-and flow-velocity-dependent electrical potential at the corresponding measurement electrode. The amplified flow measurement signal d is an analog measurement signal. It is provided at a first analog-to-digital converter 102, which is configured to convert the analog flow measurement signal d into a digital flow measurement signal D. The digital flow measurement signal D is provided at a microcontroller 101. The microcontroller 101 is configured to determine the flow-velocity-dependent measurement variable on the basis of the digital flow measurement signal D.

The magnetic-inductive flowmeter 100 of the first embodiment further comprises a grounding electrode PGND, which is designed to be in contact with the medium and is configured to electrically connect the medium to be conducted to a reference potential (e.g., ground potential).

The magnetic-inductive flowmeter 100 of the first embodiment further comprises a fill-level monitoring electrode EPD arranged diametrically to the grounding electrode PGND. The fill-level monitoring electrode EPD is configured to detect partial filling of the measuring tube. For this purpose, a digital supplied test signal A is generated by the microcontroller 101 and converted into an analog supplied test signal a by means of a digital-to-analog converter 104. For the diagnosis of the magnetic-inductive flowmeter, the digital supplied test signal A has, at least in portions, a time-varying test signal strength that alternates with at least one frequency or preferably at least two frequencies. One example of a digital supplied test signal A would be a superposition of at least two sinusoidal signals with different frequencies. The generated analog supplied test signal a is amplified by means of an amplifier 107 and fed into the fill-level monitoring electrode EPD. An analog test measurement signal a*, which results from the interaction of the analog supplied test signal a with the connecting cable and the medium, is tapped via the fill-level monitoring electrode EPD. It is converted into a digital test measurement signal A* via a second analog-to-digital converter 103 and provided at the microcontroller 101. Depending on the application or the digital supplied test signal A, the digital test measurement signal A* contains the piece of information regarding the cable quality (cable break), the conductivity of the medium, the current fill level of the measuring tube, the presence of gas bubbles at one of the measurement electrodes and/or the presence of a deposit on one of the electrodes.

The microcontroller 101 is configured to extract the component of the digital test measurement signal A* from the digital flow measurement signal D using a correlation and to determine the flow-velocity-dependent measurement variable using the corrected flow measurement signal D′.

Simultaneously feeding the analog supplied test signal a and measuring the analog flow measurement signal d results in the supplied test signal a being reflected in the measured flow measurement signal d. This leads to a distorted flow-velocity-dependent measurement variable.

Therefore, until now, diagnosis was not carried out during the flow measurement. Since, according to the invention, the analog test measurement signal a* is also measured and is therefore known, the influence of the supplied test signal a on the flow measurement can be compensated or minimized.

The microcontroller 101 is also configured to determine, in particular simultaneously, a diagnostic variable or a process variable on the basis of the digital test measurement signal A* and the, in particular digital, supplied test signal A. The diagnostic variable can be a variable that represents a piece of information regarding a current fill level of the medium, the conductivity of the medium, a cable break of an electrical connecting line, the presence of gas bubbles at the measurement electrode E1 and/or at the additional electrode E2 and/or the presence of a deposit on the measurement electrode E1 and/or on the additional electrode E2. A microcontroller 101 configured to detect bubbles is disclosed in DE 10 2009 028 659A 1 . Methods for detecting cable breaks are disclosed in DE 10 2009 045 904 A1, WO 2019 121 101 A1, and DE 10 2014 119 453 A1. The detection of sedimentation by means of a supplied test signal A is taught in DE 10 2018 132 058 A1. WO 2010 121 908 A1 discloses the determination of the conductivity of the medium by means of the measurement electrodes. Patent specifications EP 1 108 988 A1 and DE 10 2007 014 469 A1 each teach a method for deposit detection. All patent specifications cited are referenced in their entirety. In addition to the digital test measurement signal A*, a digital correlation test signal A″ can also be ascertained from the digital flow measurement signal D. By comparing the two signals, a piece of information regarding a partial filling of the measuring tube 2 can be determined. Additionally or alternatively, an influence of the electronic components of the measuring circuit 23 on the digital flow measurement signal D can be compensated based on the digital correlation test signal A″ and the digital test measurement signal A *. The digital correlation test signal A″ can be ascertained, for example, by applying a fast Fourier transform to the digital flow measurement signal D. Alternatively, the digital correlation test signal A″ can also be determined from the digital flow measurement signal D using a high-pass filter.

FIG. 3 shows a schematic representation of a second embodiment of the magnetic-inductive flowmeter 200, in particular of the measuring circuit 123. The first measurement electrode E1, the second measurement electrode E2, and also the grounding electrode PGND are electrically connected to a multiplexer MUX. The multiplexer MUX is electrically connected via its two outputs to an amplifier 106a and is configured to connect the three inputs for the first measurement electrode E1, the second measurement electrode E2, and the grounding electrode PGND switchably to the two outputs. Thus, the individual electrical potentials applied to the measurement electrodes E1, E2 can be measured relative to each other and to a reference potential (step I). The first measurement electrode E1 and the second measurement electrode E2 are also electrically connected to an additional amplifier 106b. The amplified analog first flow measurement signal d1 is provided at the first analog-to-digital converter 102. The amplified analog second flow measurement signal d2 is provided at a third analog-to-digital converter 105. Both analog-to-digital converters 102, 105 are configured to convert the incoming analog measurement signal into a digital measurement signal so that the microcontroller (not shown) can use the digital first flow measurement signal D1 and the digital second flow measurement signal D2, in particular a difference between the two flow measurement signals D1, D2 to determine the flow-velocity-dependent measurement variable and the diagnostic variable (step II). The analog supplied test signal a is supplied as described for FIG. 1 (step III). Unlike in the first embodiment, in the second embodiment, an amplifier 108 is arranged between the fill-level monitoring electrode EPD and the second analog-to-digital converter 103 for a high-resolution feedback measurement of the analog test measurement signal a *.

### LIST OF REFERENCE SIGNS

Magnetic-inductive flowmeter 1
Measuring tube 2
Carrier tube 3
Liner 4
Magnetic-field-generating device 5
Operating circuit 7
Controller circuit 10
Coil 13i
Coil core 14i
Measurement electrode 17i
Return path body 19
Pole shoe 21i
Fill-level monitoring electrode 22
Measuring circuit 23
Evaluation circuit 24
Microcontroller 101
First analog-to-digital converter 102
Second analog-to-digital converter 103
Digital-to-analog converter 104
Third analog-to-digital converter 105
Amplifier 106i
Amplifier 107
Amplifier 108
First measurement electrode E1
Second measurement electrode E2
Fill-level monitoring electrode EPD
Grounding electrode PGND
Multiplexer MUX
Analog flow measurement signal d
Digital flow measurement signal D
Corrected digital flow measurement signal D′
Analog first flow measurement signal d1
Analog second flow measurement signal d2
Digital first flow measurement signal D1
Digital second flow measurement signal D2
Analog supplied test signal a
Digital supplied test signal A
Analog test measurement signal a*
Digital test measurement signal A*
Digital correlation test signal A″

1-12. (canceled)

13. A magnetic-inductive flowmeter for ascertaining a flow-velocity-dependent measurement variable of a flowable medium, comprising:
a measuring tube for conducting the medium;
at least one measurement electrode arranged on the measuring tube;
an additional electrode arranged on the measuring tube;
a magnetic-field-generating device for generating a magnetic field that penetrates the measuring tube at least in portions;
a measuring circuit with a microcontroller,
wherein the measuring circuit has a first analog-to-digital converter, which is electrically connected to the at least one measurement electrode and the microcontroller,
wherein the first analog-to-digital converter is configured to convert an analog flow measurement signal provided via the at least one measurement electrode into a digital flow measurement signal,
wherein the measuring circuit has a digital-to-analog converter, which is electrically connected to the additional electrode,
wherein the digital-to-analog converter is configured to convert a digital supplied test signal provided via the microcontroller into an analog supplied test signal and to feed the latter into the additional electrode,
wherein the measuring circuit has a second analog-to-digital converter, which is electrically connected to the additional electrode,
wherein the second analog-to-digital converter is configured to convert an analog test measurement signal provided via the additional electrode into a digital test measurement signal,
wherein the microcontroller is configured to extract the component of the digital test measurement signal from the digital flow measurement signal using a correlation and to determine the flow-velocity-dependent measurement variable using the corrected flow measurement signal, and/or
wherein the microcontroller is configured to determine a diagnostic variable or a process variable on the basis of the digital test measurement signal.

14. The magnetic-inductive flowmeter according to claim 13,
wherein the additional electrode is a fill-level monitoring electrode.

15. The magnetic-inductive flowmeter according to claim 13,
wherein the additional electrode is an additional measurement electrode.

16. The magnetic-inductive flowmeter according to claim 13,
wherein the diagnostic variable comprises information regarding a current fill level of the medium, the conductivity of the medium, a cable break of an electrical connecting line, the presence of gas bubbles at the measurement electrode and/or at the additional electrode and/or the presence of a deposit on the measurement electrode and/or on the additional electrode.

17. The magnetic-inductive flowmeter according to claim 13,
wherein the digital supplied test signal is time-varying at least in portions and has a test signal strength that alternates with at least one frequency.

18. The magnetic-inductive flowmeter according to claim 13,
wherein the digital supplied test signal is time-varying at least in portions and has a supplied test signal strength that alternates with at least two frequencies.

19. The magnetic-inductive flowmeter according to claim 13,
wherein the digital supplied test signal consists of a superposition of at least two sinusoidal signals with different frequencies.

20. The magnetic-inductive flowmeter according to claim 13,
wherein noise, is impressed on the digital supplied test signal at least in portions.

21. The magnetic-inductive flowmeter according to claim 13,
wherein the microcontroller is configured to extract a, correlation test signal from the digital flow measurement signal.

22. The magnetic-inductive flowmeter according to claim 21,
wherein the measuring circuit is configured to determine a piece of information regarding a partial filling of the measuring tube on the basis of the digital correlation test signal and the digital test measurement signal.

23. The magnetically inductive flowmeter according to claim 21,
wherein the measuring circuit is configured to compensate for an influence of electronic components of the measuring circuit on the digital flow measurement signal on the basis of a compensation variable ascertained from the digital correlation test signal and the digital test measurement signal.

24. The magnetic-inductive flowmeter according to claim 13,
wherein the magnetic-inductive flowmeter comprises a first measurement electrode and a second measurement electrode,
wherein the first analog-to-digital converter is electrically connected to the first measurement electrode,
wherein the first analog-to-digital converter is configured to convert an analog first flow measurement signal provided via the first measurement electrode into a digital first flow measurement signal,
wherein the measuring circuit has a third analog-to-digital converter, which is electrically connected to the second measurement electrode and the microcontroller,
wherein the third analog-to-digital converter is configured to convert an analog second flow measurement signal provided via the second measurement electrode into a digital second flow measurement signal,
wherein the digital first flow measurement signal and the digital second flow measurement signal are also used to determine the flow-velocity-dependent measurement variable.
